(19) United States
(12) Patent Application Publication
(10) Pub. No.: US 2023/0163374 A1
(43) Pub. Date: May 25, 2023

(54) CHARGE AND DISCHARGE CONTROL DEVICE AND CHARGE AND DISCHARGE CONTROL METHOD

(71) Applicant: Mitsubishi Electric Corporation, Tokyo (JP)

(72) Inventor: Satoshi HARA, Tokyo (JP)

(73) Assignee: Mitsubishi Electric Corporation, Tokyo (JP)

(21) Appl. No.: 17/923,240

(22) PCT Filed: Jul. 28, 2020
(86) PCT No.: PCT/JP2020/028897

§ 371 Date: Nov. 4, 2022

(51) Int. Cl. H01M 10/48; H02J 7/00; H01M 10/44

(52) U.S. Cl. CPC H01M 10/482; H02J 7/0018; H02J 7/0016; H01M 10/441

(57) ABSTRACT

A charge and discharge control device, which is to be connected with a battery system including a plurality of battery modules, includes an obtaining unit that obtains information on states of the battery modules, an estimation unit that estimates a parameter indicating each of the states of the battery modules by using the information on the states of the battery modules obtained by the obtaining unit, and an output control unit that compares the parameters of the battery modules estimated by the estimation unit, and controls division of output among the battery modules so as to reduce difference between charge states of the battery modules on the basis of a result of comparison.

### FIELD

The present disclosure relates to a charge and discharge control device and a charge and discharge control method for controlling a battery system in which a plurality of batteries having different characteristics from each other are present.

### BACKGROUND

With the increase in vehicles using batteries such as electric vehicles and hybrid electric vehicles, methods for reusing batteries having used in such vehicles and therefore being degraded and batteries having different characteristics in module configurations, battery materials and the like depending on the vehicle types have been considered. For example, ways for reusing batteries that can no longer be used in electric vehicles with large outputs, as batteries for stationary applications with small outputs have been considered. Under present situation, however, use of such batteries remains within applications of batteries with equivalent characteristics such as batteries with substantially equal degradation levels, or batteries of the same types. Thus, in order to reuse various batteries, there has been demand for development of a control method for effectively and efficiently using batteries having different characteristics from each other.

Patent Literature 1 teaches a technology of a power supply control device, which is mounted on a vehicle including a plurality of battery devices and controls charging and discharging of the battery devices, calculating and comparing losses during charging and discharging, assigning power when a loss is small, and adjusting the charge states, that is, the states of charge (SOCs).

### CITATION LIST

### Patent Literature

Patent Literature 1: Japanese Patent Application Laid-open No. 2019-187148

### SUMMARY

### Technical Problem

According to the related art technology, however, powers are not assigned and the SOCs are not adjusted when losses are large during charging or discharging, which is problematic in that the efficiency of the battery system may be lowered. In particular, in a case where batteries having different characteristics from each other are present in one battery system and there are significant differences in capacity, resistance, and the like between the batteries, the characteristics of the battery system are limited to those of a battery with a small capacity or those of a battery with a large resistance, which lowers the efficiency of the battery system.

The present disclosure has been made in view of the above, and an object thereof is to provide a charge and discharge control device capable of reducing or preventing decrease in the efficiency of a battery system including battery modules with different characteristics.

### Solution to Problem

To solve the above problem and achieve an object, the present disclosure is directed to a charge and discharge control device to be connected to a battery system including a plurality of battery modules. The charge and discharge control device includes: an obtaining unit to obtain information on states of the battery modules; an estimation unit to estimate a parameter indicating each of the states of the battery modules by using the information on the states of the battery modules obtained by the obtaining unit; and an output control unit to compare the parameters of the battery modules estimated by the estimation unit, and control division of output among the battery modules so as to reduce difference between charge states of the battery modules on the basis of a result of comparison.

### Advantageous Effects of Invention

According to the present disclosure, a charge and discharge control device produces an effect of being capable of reducing or preventing decrease in the efficiency of a battery system including battery modules with different characteristics.

### BRIEF DESCRIPTION OF DRAWINGS

FIG. 1 is a diagram illustrating an example of a configuration of a charge and discharge control system according to an embodiment.

FIG. 2 is a diagram illustrating an example of a configuration of a charge and discharge control device according to the embodiment.

FIG. 3 is a diagram illustrating an example of a configuration of a direct current (DC)-DC converter according to the embodiment.

FIG. 4 is a diagram illustrating the relation between an output of a battery module and an output of a DC-DC converter in a battery system according to the embodiment.

FIG. 5 illustrates graphs of an example of discharge curves in a case where battery modules having different characteristics are used with outputs equal to each other as a comparative example.

FIG. 6 is a first diagram explaining a method for dividing output among the battery system constituted by m battery modules performed by the charge and discharge control device according to the embodiment.

FIG. 7 is a second diagram explaining a method for dividing output among the battery system constituted by m battery modules performed by the charge and discharge control device according to the embodiment.

FIG. 8 is a table illustrating an example of division of output performed by an output control unit of the charge and discharge control device according to the embodiment in a case of pattern 1: SOC₁≥SOCₙ, Q₁≥Qₙ, and R₁≥Rₙ.

FIG. 9 is a graph illustrating an example of a discharge curve of a battery module 111-1 in a case where output is divided in pattern 1 by the output control unit of the charge and discharge control device according to the embodiment.

FIG. 10 is a graph illustrating an example of a discharge curve of a battery module 111-n in a case where output is divided in pattern 1 by the output control unit of the charge and discharge control device according to the embodiment.

FIG. 11 is a table illustrating an example of division of output performed by the output control unit of the charge and discharge control device according to the embodiment in a case of pattern 2: SOC₁≥SOCₙ, Q₁≥Qₙ, and R₁≤Rₙ.

FIG. 12 is a table illustrating an example of division of output performed by the output control unit of the charge and discharge control device according to the embodiment in a case of pattern 3: SOC₁≥SOCₙ, Q₁≤Qₙ, and R₁≥Rₙ.

FIG. 13 is a table illustrating an example of division of output performed by the output control unit of the charge and discharge control device according to the embodiment in a case of pattern 4: SOC₁≥SOCₙ, Q₁≤Qₙ, and R₁≤Rₙ.

FIG. 14 is a table illustrating an example of division of output performed by the output control unit of the charge and discharge control device according to the embodiment in a case of pattern 5: SOC₁≤SOCₙ, Q₁≥Qₙ, and R₁≥Rₙ.

FIG. 15 is a graph illustrating an example of a discharge curve of a battery module 111-1 in a case where output is divided in pattern 5 by the output control unit of the charge and discharge control device according to the embodiment.

FIG. 16 is a graph illustrating an example of a discharge curve of a battery module 111-n in a case where output is divided in pattern 5 by the output control unit of the charge and discharge control device according to the embodiment.

FIG. 17 is a table illustrating an example of division of output performed by the output control unit of the charge and discharge control device according to the embodiment in a case of pattern 6: SOC₁≤SOCₙ, Q₁≥Qₙ, and R₁≤Rₙ.

FIG. 18 is a table illustrating an example of division of output performed by the output control unit of the charge and discharge control device according to the embodiment in a case of pattern 7: SOC₁≤SOCₙ, Q₁≤Qₙ, and R₁≥Rₙ.

FIG. 19 is a table illustrating an example of division of output performed by the output control unit of the charge and discharge control device according to the embodiment in a case of pattern 8: SOC₁≤SOCₙ, Q₁≤Qₙ, and R₁≤Rₙ.

FIG. 20 is a diagram illustrating an example of discharge curves of individual battery modules in a case where the output control unit of the charge and discharge control device according to the embodiment performs division of output in pattern 1.

FIG. 21 is a diagram illustrating an example of discharge curves in a case where the output control unit of the charge and discharge control device according to the embodiment does not switch the method of dividing output.

FIG. 22 is a diagram illustrating an example of discharge curves in a case where the output control unit of the charge and discharge control device according to the embodiment switches the method of dividing output.

FIG. 23 is a flowchart illustrating the operation of charge and discharge control performed by the charge and discharge control device according to the embodiment.

FIG. 24 is a first graph illustrating an effect produced by the charge and discharge control device according to the embodiment.

FIG. 25 is a second graph illustrating an effect produced by the charge and discharge control device according to the embodiment.

FIG. 26 is a diagram illustrating an example of a case where processing circuitry included in the charge and discharge control device according to the embodiment is constituted by a processor and a memory.

FIG. 27 is a diagram illustrating an example of a case where processing circuitry included in the charge and discharge control device according to the embodiment is constituted by dedicated hardware.

### DESCRIPTION OF EMBODIMENTS

A charge and discharge control device and a charge and discharge control method according to an embodiment of the present disclosure will be described in detail below with reference to the drawings.

### Embodiment

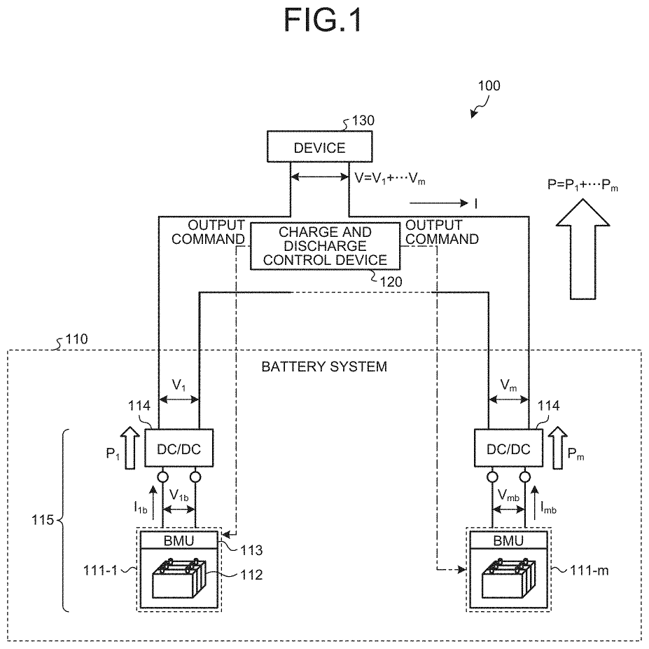

FIG. 1 is a diagram illustrating an example of a configuration of a charge and discharge control system 100 according to an embodiment. The charge and discharge control system 100 includes a battery system 110, a charge and discharge control device 120, and a device 130. The battery system 110 includes replaceable battery modules 111-1 to 111-m, and DC-DC converters 11-1 the number of which is m. “m” is an integer not smaller than 2. In the description below, each of the battery modules 111-1 to 111-m may be referred to as a battery module 111 when the battery modules 111-1 to 111-m are not distinguished from each other. The battery system 110 has a configuration in which units 115, each of which includes a battery module 111 and a DC-DC converter 114 are connected with each other, are connected in series or in parallel with each other. Although not illustrated in FIG. 1, assume that the battery system 110 includes m units 115. The battery modules 111-1 to 111-m may have different characteristic from each other. Thus, the battery system 110 is constituted by the replaceable battery modules 111 having different characteristic from each other.

As illustrated in FIG. 1, in the battery system 110, voltages applied to the respective units 115 are represented by voltages V₁, . . . , Vₘ, and currents flowing through the respective units 115 are represented by currents I₁, . . . , Iₘ. The battery system 110 can indirectly control the voltages of the respective units 115, that is, the respective battery modules 111 or the currents flowing to the respective battery modules 111 by controlling the voltage V₁, . . . , Vₘ when the units 115 are connected in series or controlling the current I₁, . . . , Iₘ when the units 115 are connected in parallel. In addition, as illustrated in FIG. 1, in the battery system 110, outputs from the respective units 115 are represented by outputs P₁, . . . , Pₘ, the voltages applied to the respective battery modules 111 are represented by V_{1b}, . . . , V_{mb}, and the currents flowing through the respective battery modules 111 are represented by I_{1b}, . . . , I_{mb}. The output P₁=V₁×I₁, and the output Pₘ=Vₘ×Iₘ.

The battery modules 111 each include cells 112 and a battery management unit (BMU) 113. The battery modules 111 each have a configuration in which cells 112, a cell, being the smallest unit, are connected in series or in parallel with each other, and the cells 112 are connected with the BMU 113. The cells 112 are chargeable and dischargeable secondary batteries, and the examples thereof include, but are not limited to, lithium-ion batteries, nickel-metal hydride batteries, and lead storage batteries. In each BMU 113, thresholds such as an upper and lower limit, voltage, a maximum charge and discharge current, and a maximum cell temperature are set for the purpose of preventing overcharge, overdischarge, overvoltage, overcurrent, temperature anomaly, and the like of the cells 112. The BMUs 113 each monitor the states of the cells 112, by performing such as protective functions, voltage measurement, current measurement, power measurement, temperature measurement of the battery system 110, full charge management, and remaining capacity management, using the aforementioned thresholds.

In the charge and discharge control system 100, the device 130 refers to a load to which the battery system 110 discharges and refers to a power supply that supplies power when the battery system 110 is charged. Although not illustrated in FIG. 1, the charge and discharge control system 100 can include a plurality of devices 130.

Each of the DC-OC converters 114 converts voltage output from the battery module 111 or the device 130, and outputs the converted voltage. For example, the DC-DC converter 114 connected with the battery module 111-1 converts the voltage V_{1b} and the current I_{1b} into voltage V₁ and current I₁, respectively, and outputs the voltage V₁ and the current I₁ at the time of discharging. Furthermore, the DC-DC converter 114 converts the voltage V₁ and the current I₁ into the voltage V_{1b} and the current I_{1b}, respectively, and outputs the voltage V_{1b} and the current I_{1b} at the time of charging.

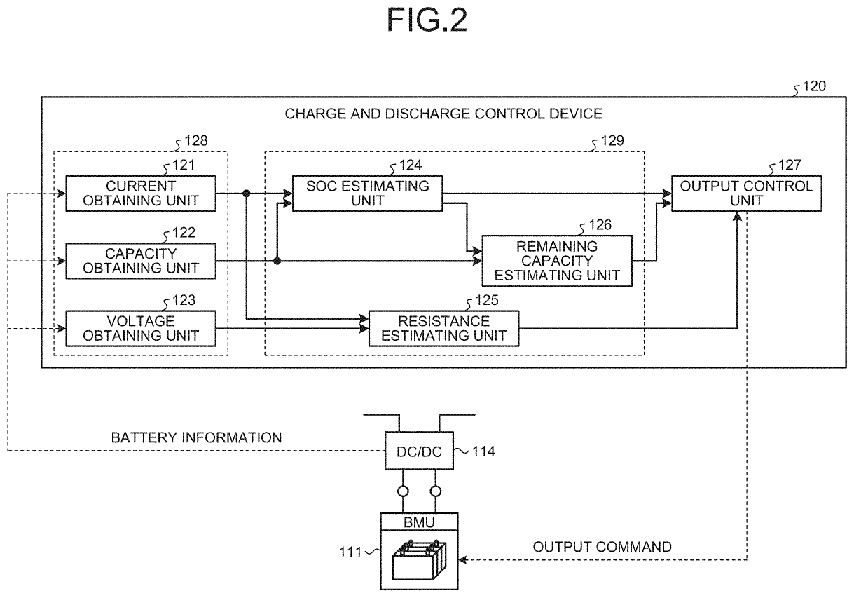

The charge and discharge control device 120 is connected with the battery system 110. The charge and discharge control device 120 obtains information on the individual battery modules 111, divides an output required for a load that is a device 130, among the battery modules 111 at the time of discharging, and divides power input from a power supply that is a device 130, among the battery modules 111 at the time of charging. The charge and discharge control device 120 transmits output commands to the individual battery modules 111, and controls division of output among the battery modules 111. A configuration of the charge and discharge control device 120 will be described in detail. FIG. 2 is a diagram illustrating an example of a configuration of the charge and discharge control device 120 according to the embodiment. The charge and discharge control device 120 includes a current obtaining unit 121, a capacity obtaining unit 122, a voltage obtaining unit 123, an SOC estimating unit 124, a resistance estimating unit 125, a remaining capacity estimating unit 126, and an output control unit 127. In the charge and discharge control device 120, the current obtaining unit 121, the capacity obtaining unit 122, and the voltage obtaining unit 123 constitute an obtainment unit 128. In addition, the SOC estimating unit 124, the resistance estimating unit 125, and the remaining capacity estimating unit 126 constitute an estimation unit 129.

The obtainment unit 128 obtains information on the states of the battery modules 111-1 to 111-m included in the battery system 110.

Specifically, in the obtainment unit 128, the current obtaining unit 121 obtains information on current I_{b} in the battery module 111 measured by an ammeter in the corresponding DC-DC converter 114 from battery information transmitted from each of the DC-DC converters 114. In the description below, current I_{b} obtained by the current obtaining unit 121 from a DC-DC converter 114 connected with a battery module 111-n may be referred to as current I_{nb}. Note that n is an integer satisfying 1≤n≤m. The voltage obtaining unit 123 obtains information on voltage V_{b} of the battery module 111 measured by a voltmeter in the corresponding DC-DC converter 114 from the battery information transmitted from each of the DC-DC converters 114. In the description below, voltage V_{b} obtained by the voltage obtaining unit 123 from a DC-DC converter 114 connected with a battery module 111-n may be referred to as voltage V_{nb}.

The capacity obtaining unit 122 estimates the capacity of each of the battery modules 111 on the basis of the battery information transmitted from the individual DC-DC converters 114. Note that the capacity of a battery module 111 which the capacity obtaining unit 122 estimates, is assumed to be a full-charge capacity (FCC). The full-charge capacity is a sum of currents when a battery module 111 is charged within a control range of the battery module 111, such as within a voltage range of 2.5 V to 4.2 V of the cells 112, for example. When replaceable battery modules 111 are used, a battery module 111 having a different full-charge capacity from that of a battery module 111 before replacement may be connected after the replacement in the battery system 110. Because the full-charge capacity may vary depending on a battery module 111 to be replaced with, the capacity obtaining unit 122 estimates the full-charge capacities of the individual battery modules 111. In a method of estimating the full-charge capacity of a battery module 111, the capacity obtaining unit 122 may obtain a sum of currents when the battery module 111 is charged within a control range of the battery module 111, such as within a voltage range of 2.5 V to 4.2 V of the cells 112, for example, or may use information on the full-charge capacity transmitted from the BMU 113. When information on the SOC can be obtained from the BMU 113, the capacity obtaining unit 122 can also estimate the full-charge capacity of a battery module 111 on the basis of the change in the amount of current and the change in the SOC. In the description below, the full-charge capacity of a battery module 111-n obtained or estimated by the capacity obtaining unit 122 may be referred to as FCCₙ.

The estimation unit 129 estimates a parameter indicating a state of each of the battery modules 111-1 to 111-m by using information on the respective states of the battery modules 111-1 to 111-m obtained by the obtainment unit 128.

Specifically, in the estimation unit 129, the SOC estimating unit 124 estimates the SOC of each battery module 111 by using the information on the current I_{b} obtained by the current obtaining unit 121 and the full-charge capacity estimated by the capacity obtaining unit 122. The SOC is a parameter indicating the charge state of a battery module 111, SOC=0 means a state in which a battery module 111 has fully discharged, and SOC=1 means a state in which a battery module 111 is fully charged. A method for estimating the SOC by the SOC estimating unit 124 may be a common method. In the embodiment, a method of calculating the SOC by using a current integration method will be described. The SOC estimating unit 124 can calculate the SOC by integrating current flowing into a battery module 111 from estimation start time as expressed by formula (1).

$$\begin{matrix}[ Formula 1 ] & \\ SOC ( t ) = \frac{1}{FCC} {{\int }_{0}}^{t} Idt + SOC ( 0 ) & ( 1 )\end{matrix}$$

In formula (1) SOC(t) is a parameter representing the SOC at certain time, FCC is a parameter representing the full-charge capacity, and SOC(0) is a parameter representing a charge amount at the start time charge amount estimation. In the description below, the SOC(t) of a battery module 111-n estimated by the SOC estimating unit 124 may be referred to as SOCₙ.

The resistance estimating unit 125 estimates the resistance R of each battery module 111 by using information on the current I_{b} obtained by the current obtaining unit 121 and information on the voltage V_{b} obtained by the voltage obtaining unit 123. A method for estimating the resistance R of a battery module 111 by the resistance estimating unit 125 may be a common method. In the embodiment, a method of calculating the resistance R by using Ohm's law will be described. Upon obtaining the voltage V_{b} and the current I_{b} of a battery module 111 at certain time, the resistance estimating unit 125 calculates the resistance R by formula (2). Upon receiving the voltage V_{nb} and the current I_{nb} of the battery module 111-n at a certain time, for example, the resistance estimating unit 125 can calculate the resistance Rₙ by formula (2).

[Formula 2]

R=V_{b}/I_{b}(Ω) (2)

The remaining capacity estimating unit 126 estimates the remaining capacity Q of a battery module 111 by using the full-charge capacity of the battery module 111 estimated by the capacity obtaining unit 122 and the SOC of the battery module 111 estimated by the SOC estimating unit 124. The remaining capacity estimating unit 126 calculates the remaining capacity Q by obtaining a product of the FCC and the SOC as expressed by formula (3). The remaining capacity estimating unit 126 can calculate the remaining capacity Qₙ of a battery module 111-n, for example, by obtaining a product of the FCCₙ and SOCₙ as expressed by formula (3). Alternatively, when the remaining capacity Q of a battery module 111 is transmitted from the BMU 113 of the battery module 111, the remaining capacity estimating unit 126 may use the remaining capacity Q transmitted from the BMU 113.

[Formula 3]

Q×FCC×SOC (3)

As described above, the estimation unit 129 estimates the SOCs, which are charge states, the capacity values indicating the remaining capacities Q, and the resistances R of the battery modules 111-1 to 111-m as parameters indicating the states of the battery modules 111-1 to 111-m.

The output control unit 127 compares the parameters of the battery modules 111-1 to 111-m estimated by the estimation unit 129, and controls division of output among the battery modules 111-1 to 111-m on the basis of the comparison result so that the differences between the charge states of the battery modules 111-1 to 111-m become smaller. Specifically, the output control unit 127 compares the SOCs of the respective battery modules 111 estimated by the SOC estimating unit 124, compares the resistances R of the respective battery modules 111 estimated by the resistance estimating unit 125, and compares the remaining capacities Q of the respective battery modules 111 estimated by the remaining capacity estimating unit 126. The output control unit 127 calculates an output of each of the battery modules 111 at discharge on the basis of the comparison results, and outputs an output command to each of the battery modules 111. A method for comparing the parameters by the output control unit 127 will be described later.

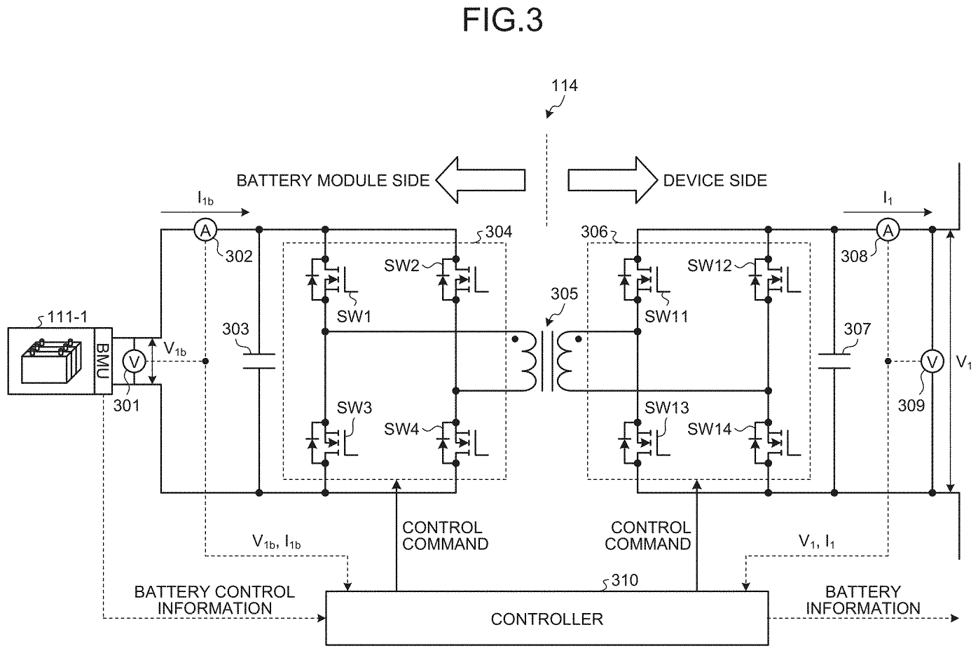

A configuration of the DC-DC converters 114 will be described. FIG. 3 is a diagram illustrating an example of a configuration of a DC-DC converter 114 according to the embodiment. FIG. 3 illustrates a configuration in which the DC-DC converter 114 is connected with a battery module 111-1. The DC-DC converter 114 has a function of stepping up or down the voltage V_{1b} of the battery module 111-1. While the DC-DC converter 114 in the example in FIG. 3 is an isolated DC-DC converter, this is an example, and the DC-DC converter 114 is not limited thereto. The DC-DC converter 114 may be a non-isolated DC-DC converter. The DC-DC converter 114 includes a voltmeter 301, an ammeter 302, a capacitor 303, a bridge circuit 304, a transformer 305, a bridge circuit 306, a capacitor 307, an ammeter 303, a voltmeter 309, and a controller 310. The bridge circuit 304 includes switching elements SW1 to SW4. The bridge circuit 306 includes switching elements SW11 to SW14.

In the DC-DC converter 114, the voltmeter 301 measures the voltage V_{1b}. The ammeter 302 measures the current I_{1b}. The ammeter 303 measures the current I₁. The voltmeter 309 measures the voltage V₁. The controller 310 obtains the voltage V_{1b} measured by the voltmeter 301 and the current I_{1b} obtained by the ammeter 302, which are connected on the battery module 111-1 side. The controller 310 obtains the current I₁ measured by the ammeter 308 and the voltage V₁ measured by the voltmeter 309, which are connected on the device 130 side. In addition, the controller 310 obtains battery control information from the battery module 111-1. The controller 310 generates control commands for the bridge circuit 304 and the bridge circuit 306 and controls switching of the switching elements SW1 to SW4 and the switching elements SW11 to SW14 by using the obtained information. The controller 310 also transmits battery information including the voltage V_{1b} measured by the voltmeter 301 and the current I_{1b} measured by the ammeter 302, to the charge and discharge control device 120. The battery information may include information other than the voltage V_{1b} and the current I_{1b}.

In the embodiment, if the units 115, that is, the battery modules 111 are connected in series as the characteristics of the configuration of the battery system 110, the sum of the voltages V₁ to Vₘ the DC-DC converters 114 connected with the respective battery modules 111 needs to be “V” that a total voltage required for the device 130 as expressed by formula (4).

[Formula 4]

V₁+ . . . +Vₘ=V(V) (4)

On the other hand, if the units 115, that is, the battery modules 111 are connected in parallel as the characteristics of the configuration of the battery system 110, the sum of the currents I₁ to Iₘ of the DC-DC converters 114 connected with respective battery modules 111 needs to be “I” that is a total current required for the device 130 as expressed by formula (5).

[Formula 5]

I₁+ . . . +Iₘ=I(A) (5)

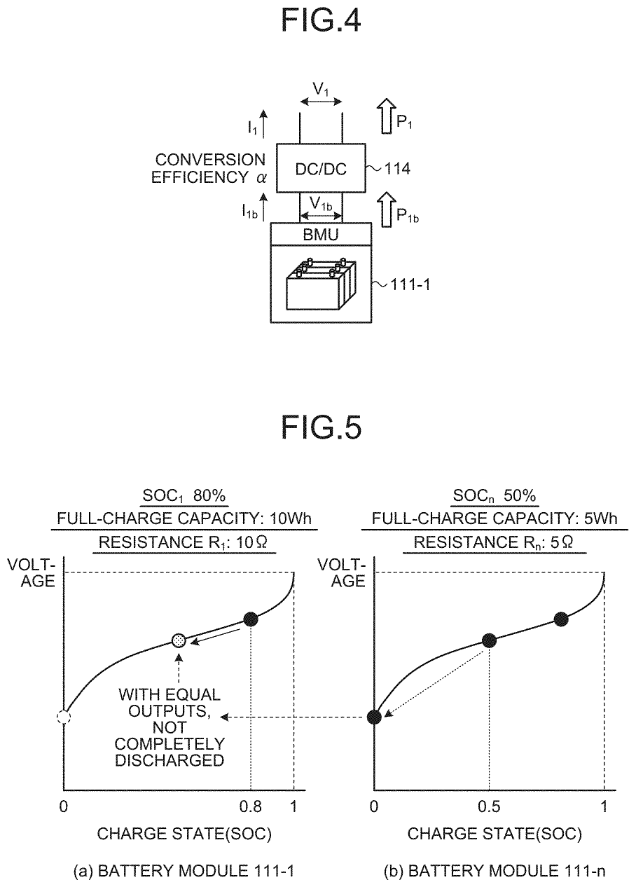

The relation between an output P_{1b} of a battery module 111 and an output P₁ of a DC-DC converter 114 will now be described with reference to FIG. 4. FIG. 4 is a diagram illustrating the relation between the output P_{1b} of the battery module 111-1 and the output P₁ of the DC-DC converter 114 in the battery system 110 according to the embodiment. FIG. 4 illustrates a configuration in which the DC-DC converter 114 is connected with the battery module 111-1. When the conversion efficiency of the DC-DC converter 114 is represented by α, the relation between the output P_{1b} of the battery module 111-1 and the output P₁ of the DC-DC converter 114 can be expressed as in formula (6).

[Formula 6]

P_{1b}=αP₁(W) (6)

In addition, when the voltage of the battery module 111-1 is represented by V_{1b}, the current thereof is represented by I_{1b}, and the voltage and the current resulting from the conversion by the DC-DC converter 114 are represented by V₁ and I₁, respectively, formula (6) can be expressed as in formula (7).

[Formula 7]

V_{1b}I_{1b}=αV₁I₁(W) (7)

Thus, the current I_{1b} can be expressed as in formula (8) on the basis of formula (7).

$$\begin{matrix}[ Formula 8 ] & \\ {I}_{1 b} = α \frac{{V}_{1}}{{V}_{1 b}} {I}_{1} ( A ) & ( 8 )\end{matrix}$$

As expressed by formula (8), the battery system 110 can indirectly control the battery module 111-1 by controlling the voltage V₁ and the current I₁ on the device 130 side of the DC-DC converter 114.

While the DC-DC converter 114 has a voltage measuring function and a current measuring function in the embodiment, the DC-DC converter 114 is not limited thereto. Even when a battery module 111 performs measurement of voltage and current therein and sends the voltage and the current to the BMU 113, it is sufficient that the charge and discharge control device 120 is capable of directly or indirectly obtaining information on the voltage and current measured in the battery module 111 from the BMU 113. In addition, when the full-charge capacities of the battery modules 111 are known in advance, the charge and discharge control device 120 need not perform the estimation by the capacity obtaining unit 122 and need not obtain the full-charge capacities from the BMUs 113. Note that the DC-DC converters 114 connected with the respective battery modules 111 are all assumed to have the same conversion efficiencies α.

Next, a method for comparing parameters performed by the output control unit 127 of the charge and discharge control device 120 will be described. The parameters compared by the output control unit 127 are the remaining capacities Q, the charge states SOC, and the resistances R of the individual battery modules 111 as described above.

FIG. 5 illustrates, as a comparative example, graphs of an example of discharge curves when battery modules 111 having different characteristics are used with outputs equal to each other. In FIG. 5, (a) on the left side is a discharge curve of the battery module 111-1, where SOC₁=80%, full-charge capacity=10 Wh, remaining capacity Q₁=8 Wh, and resistance R₁=10Ω. (b) on the right is a discharge curve of a battery module 111-n, where SOCₙ=50%, full-charge capacity=5 Wh, remaining capacity Qₙ=2.5 Wh, and resistance Rₙ=5Ω. When discharges are started with equal outputs, the battery module 111-n with the smaller remaining capacity Qₙ and the smaller SOCₙ can be completely discharged. However, the capacity of the battery module 111-1 that has the remaining capacity Q₁ and the SOC₁ larger than those of the battery module 111-n remains at the completion time of discharge of the battery system 110, thereby lowering the efficiency of the battery system 110. Furthermore, when the battery modules 111 are used with the outputs equal to each other, the loss or the battery module 111-1 that has a larger resistance R becomes large, thereby lowering the efficiency of the battery system 110.

Thus, in the embodiment, the charge and discharge control device 120 controls division of output so as to resolve difference in the SOCs of the battery modules 111 and to reduce Joule heat.

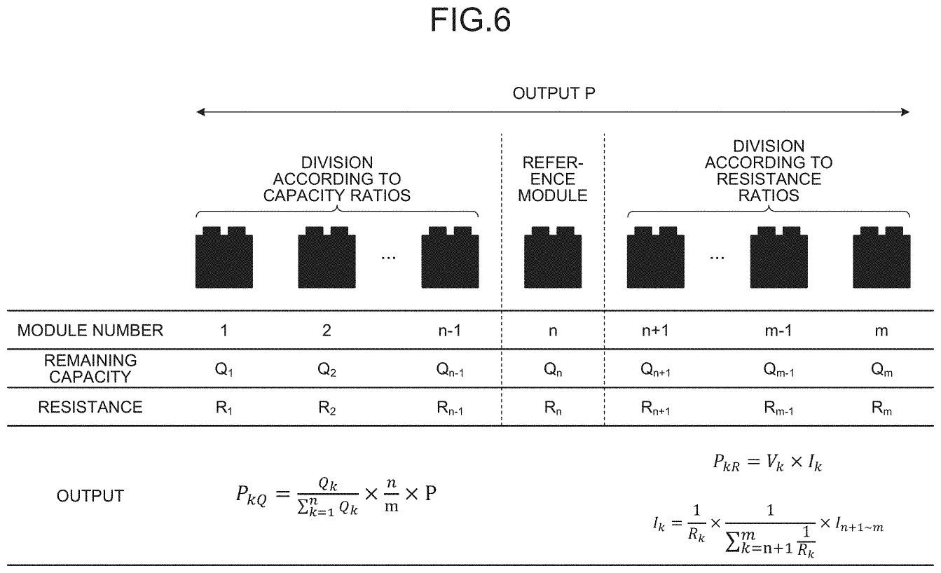

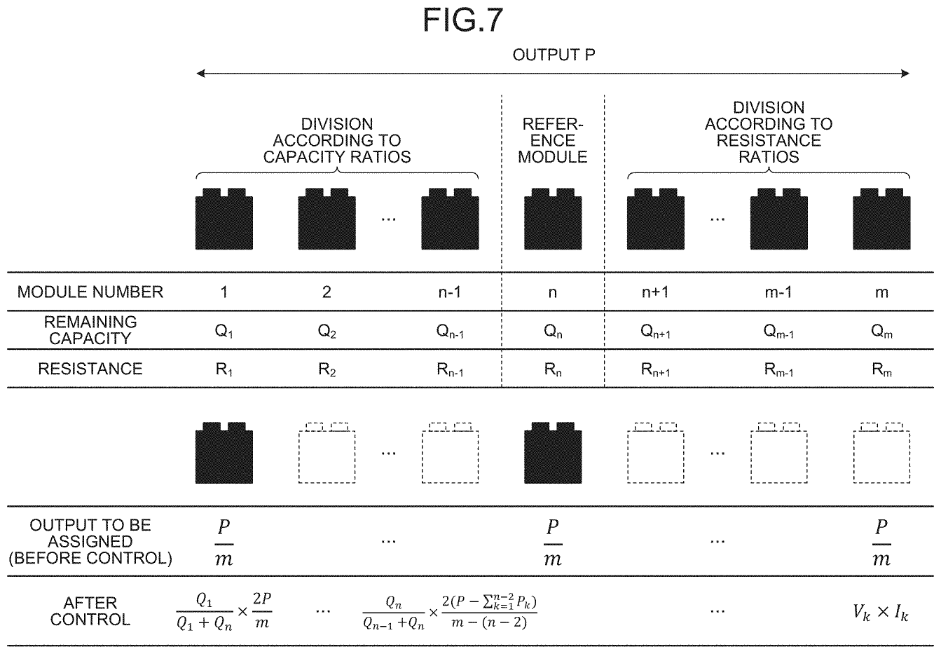

A method for dividing output among the battery modules 111 performed by the charge and discharge control device 120 described. FIG. 6 is a first diagram explaining a method for dividing output among the battery system 110 constituted by m battery modules 111 performed by the charge and discharge control device 120 according to the embodiment. In FIG. 6, branch numbers such as “1” and “m” of the battery modules 111-1 to 111-m will be referred to as module numbers, and it is assumed that the module number at the center is “n”. The same applies to FIG. 7 explained below. Herein, assume that the charge and discharge control device 120, with respect to the battery module 111-n with the central module number among the m battery modules 111, divides output in accordance with capacity ratios among the battery modules 111-1 to 111-(n−1) the numbers of which are before the battery module 111-n, and divides output in accordance with resistance ratios among, the battery modules 111-(n+1) to 111-m the numbers of which are after the battery module 111-n. The charge and discharge control device 120 actually needs to determine the method for dividing output depending on the remaining capacities Q, the resistances R, and the like of the individual battery modules 111, and a method of the determination will be described later.

An output of the entire battery system 110 is represented by P. The charge and discharge control device 120 first divides output among the central battery module 111-n and the battery modules 111-1 to 111-(n−1). The output Pₙ to be divided among the battery modules 111-1 to 111-n is expressed as in formula (9).

$$[ Formula 9 ]$$

$$Pn = \frac{n}{m} ⨯ P ( W ) \qquad ( 9 )$$

The charge and discharge control device 120 divides the output Pₙ expressed by formula (9) among the battery modules 111-1 to 111-n. When the remaining capacities Q of the respective battery modules 111 are represented by Q₁, . . . , Qₙ, . . . , Qₘ, an output P_{kQ} of the battery modules 111-k is expressed by formula (10). The output P_{kQ} is a result of dividing, by the charge and discharge control device 120, output among the battery modules 111 in accordance with the ratios of the remaining capacities Q, that is, capacity ratios

$$[ Formula 10 ]$$

$${P}_{kQ} = \frac{{Q}_{k}}{{\sum }_{k = 1}^{n} {Q}_{k}} ⨯ \frac{n}{m} ⨯ P ( W ) \qquad ( 10 )$$

Subsequently, the charge and discharge control device 120 divides output among the battery modules 111-(n+1) to 111-m. When it is assumed that output is divided among the battery modules 111-(n+1) to 111-m in accordance with resistance ratios, the charge and discharge control device 120 divides current among the battery modules 111. The output of the battery modules 111-(n+1) to 111-m is expressed as P−ΣP_{kQ} that is obtained by subtracting the output ΣP_{kQ} of the battery modules 111-1 to 111-n from the output P. Thus, a value obtained by dividing the output P−ΣP_{kQ} of the battery modules 111-(n+1) to 111-m by the voltage V is each of currents Iₙ₊₁ to Iₘ flowing through the battery modules 111-(n+1) to 111-m, respectively. The currents Iₙ₊₁ to Iₘ can be expressed as in formula (11).

$$[ Formula 11 ]$$

$${I}_{n + 1 \sim m} = \frac{P - {\sum }_{k = 1}^{n} {P}_{kQ}}{V} ( A ) \qquad ( 11 )$$

Thus, the current Iₖ flowing through the k-th battery module k out of the battery modules 111-(n+1) to 111-m can be expressed as in formula (12).

$$[ Formula 12 ]$$

$${I}_{k} = \frac{1}{{R}_{k}} ⨯ \frac{1}{{\sum }_{k = n + 1}^{m} \frac{1}{{R}_{k}}} ⨯ {I}_{n + 1 \sim m} ( A ) \qquad ( 12 )$$

The charge and discharge control device 120 divides the current Iₖ among the battery modules 111 as in formula (12), and calculates an output P_{kR} to be divided among the battery modules 111 by obtaining a product of the current Iₖ and a voltage Vₖ of each battery module 111 as in formula (13).

[Formula 13]

P_{kR}=Iₖ×Vₖ(W) (13)

The charge and discharge control device 120 determines the output Pₙ of the battery module 111-n, which is a reference module, in accordance with a resistance ratio, but the output Pₙ is not limited thereto. The charge and discharge control device 120 may determine the output Pₙ of the battery module 111-n from an output obtained by subtracting the output of the battery modules 111-1 to 111-(n−1) and the output of the battery modules 111-(n+1) to 111-n from the output P of the entire battery system 110.

In the example of FIG. 6, the charge and discharge control device 120 performs division of output on a group of battery modules among which output is divided in accordance with capacity ratios and the battery module 111-n with the central module number collectively, and on a group of battery modules among which output is divided in accordance with resistance ratios collectively. However, the division method is not limited thereto. The charge and discharge control device 120 may determine an output of the battery module 111-n with the central module number and outputs of the respective battery modules 111, among which output is to be divided in accordance with capacity ratios or resistance ratios, on a one-to-one basis.

FIG. 7 is a second diagram explaining a method for dividing output among the battery system 110 constituted by m battery modules 111 performed by the charge and discharge control device 120 according to the embodiment. In the example of FIG. 7, the charge and discharge control device 120 calculates each output to be assigned from a sum of an output required of the battery module 111-n with the central module number and an output required for the target one of the battery modules 111. Specifically, when the charge and discharge control device 120 performs division in accordance with capacity ratios, because the output required of the battery system 110 is P, the output first assigned to the battery module 111-n and the battery module 111-1 that is the target battery module, among, m battery modules 111 becomes P/m+P/m=2P/m. The charge and discharge control device 120 assigns an output. P₁ to the battery module 111-1 in accordance with the capacity ratio on the basis of the obtained output as expressed by formula (14).

$$[ Formula 14 ]$$

$${P}_{1} = \frac{{Q}_{1}}{{Q}_{1} + {Q}_{n}} ⨯ \frac{2 P}{m} ( W ) \qquad ( 14 )$$

In the charge and discharge control device 120, the output of the battery module 111-n and the battery module 111-2, to which an output is to be assigned next, is (P−P₁)/(m−1)+(P−P₁)/(m−1)=2(P−P₁)/(m−1) obtained by addition of (P−P₁)/(m−1). (P−P₁)/(m−1) is obtained by dividing, among m−1 battery modules 111, a result of subtracting the output P₁ assigned to the battery module 111-1 from the output P. The charge and discharge control device 120 assigns an output P₂ to the battery module 111-2 is accordance with the capacity ratio on the basis of the obtained output as expressed by formula (15).

$$[ Formula 15 ]$$

$${P}_{2} = \frac{{Q}_{2}}{{Q}_{2} + {Q}_{n}} ⨯ \frac{2 ( P - {P}_{1} )}{m - 1} ( W ) \qquad ( 15 )$$

In a similar manner, the charge and discharge control device 120 assigns an output Pₙ₋₁ to a battery module 111-(n−1) in accordance with a capacity ratio as expressed by formula (16). In formula (16), a part with Σ on the right side is expressed as in formula (17).

$$[ Formula 16 ]$$

$${P}_{n - 1} = \frac{{Q}_{n - 1}}{{Q}_{n - 1} + {Q}_{n}} ⨯ \frac{2 ( P - {\sum }_{k = 1}^{n - 2} {P}_{k} )}{m - ( n - 2 )} ( W ) \qquad ( 16 )$$

$$[ Formula 17 ]$$

$${\sum }_{k = 1}^{n - 2} {P}_{k} = {P}_{1} + {P}_{2} … + {P}_{n - 2} \qquad ( 17 )$$

Next, a method of dividing output according to resistance ratios on a one-to-one basis performed by the charge and discharge control device 120 will be described. In the case where the battery modules 111 of the battery system 110 are connected in parallel, the charge and discharge control device 120 divides current. The charge and discharge control device 120 can calculate currents Iₙ to Iₘ assigned to battery modules 111-n to 111-m, respectively, among the m battery modules 111 of the battery system 110 such that a power obtained by subtracting the outputs of the battery modules 111-1 to 111-(n−1) from the output P of the entire battery system 110 is divided by the voltage V of the battery modules 111-n to 111-m as expressed by formula (18).

$$[ Formula 18 ]$$

$${I}_{n \sim m} = \frac{P - {\sum }_{k = 1}^{n - 1} {P}_{k}}{V} ( A ) \qquad ( 18 )$$

The charge and discharge control device 120 can divide current among the battery module 111-n, the battery module 111-(n+1), and the battery module 111-k as expressed by formula (19), formula (20), and formula (21), respectively, in a manner similar to formulas (14) to (16) of division in accordance with capacity ratios.

$$[ Formula 19 ]$$

$${I}_{n} = \frac{{R}_{n}}{{R}_{n} + {R}_{m}} ⨯ \frac{2 {I}_{n \sim m}}{m - ( n - 1 )} ( A ) \qquad ( 19 )$$

$$[ Formula 20 ]$$

$${I}_{n + 1} = \frac{{R}_{n + 1}}{{R}_{n + 1} + {R}_{m}} ⨯ \frac{2 ( {I}_{n \sim m} - {I}_{n} )}{( m - 1 ) - ( n - 1 )} ( A ) \qquad ( 20 )$$

$$[ Formula 21 ]$$

$${I}_{k} = \frac{{R}_{k}}{{R}_{k} + {R}_{m}} ⨯ \frac{2 ( {I}_{n \sim m} - {\sum }_{j = n}^{k - 1} {I}_{j} )}{( m - k + n ) - ( n - 1 )} ( A ) \qquad ( 21 )$$

The charge and discharge control device 120 can assign the output P_{kR} to the battery module 111-k by obtaining a product of the current Iₖ of the battery module 111-k assigned as expressed by the formula (21) and the voltage Vₖ of the battery module 111-k, for example.

Next, a method for dividing output on the basis of the comparison result of parameters performed by the output control unit 127 of the charge and discharge control device 120 will be described. The output control unit 127 first selects a battery module 111 to be a reference among the battery modules 111. While the output control unit 127 may determine the battery module 111 to be a reference in any manner from the battery system 110, the output control unit 127 selects a battery module 111 having a SOC the value of which is the closest to the average SOC among the battery modules 111 included in the battery system 110 as the battery module 111-n to be the reference herein. Hereinafter, a method of assigning an output by the output control unit 127 will be specifically described assuming that a battery module 111 for which the output control unit 127 determines an output is the battery module 111-1.

The output control unit 127 compares the remaining capacity Qₙ, the charge state SOCₙ, and the resistance Rₙ of the battery module 111-n with the remaining capacity Q₁, the charge state SOC₁, and the resistance R₁ of the battery module 111-1 to determine the larger or smaller of ones of the respective parameters. The number of comparison patterns is 2\hat{ }3=8. The output control unit 127 performs similar comparison between the battery module 111-n and the other battery modules 111, and determines assignment of an output to each of the battery modules 111. Hereinafter, for simplicity of explanation, it is assumed that the battery system 110 is constituted by two battery modules, which are the battery module 111-1 and the battery module 111-n, and a method of assigning an output based on the magnitudes of the respective parameters performed by the output control unit 127 will be described. As methods for dividing required output for efficiently using the battery system 110, a method of division in accordance with capacity ratios and a method of division to reduce Joule heat can be considered.

The method of division in accordance with capacity ratios is a method of dividing the required output P in accordance with the ratios of the remaining capacities Q. For example, when an output to be assigned to the battery module 111-1 is represented by P₁ and the output to be assigned to the battery module 111-n is represented by Pₙ, the relation of formula (22) is satisfied. The output control unit 127 determines the output P₁ as expressed by formula (23), and determines the output Pₙ as expressed by formula (24).

$$[ Formula 22 ]$$

$$P = {P}_{1} + {P}_{n} ( W ) \qquad ( 22 )$$

$$[ Formula 23 ]$$

$${P}_{1} = \frac{{Q}_{1}}{{Q}_{1} + {Q}_{n}} P ( W ) \qquad ( 23 )$$

$$[ Formula 24 ]$$

$${P}_{n} = \frac{{Q}_{n}}{{Q}_{1} + {Q}_{n}} P ( W ) \qquad ( 24 )$$

In the method of division to reduce Joule heat as well, the output P₁ of the battery module 111-1 and the output Pₙ of the battery module 111-n satisfy the aforementioned relation of formula (22). In addition, when controlled currents of the battery modules 111-1 and 111-n are represented by I_{1b} and I_{nb}, respectively, the joule heat of the battery system 110 can be expressed by formula (25).

[Formula 25]

P=I_{1b}²R₁+I_{nb}²Rₙ(W) (25)

With the configuration in which the battery modules 111 are connected in series or in parallel with the DC-DC converters 114 therebetween, the battery system 110 can control the currents on the battery module 111 side of a DC-DC converter 114 relatively freely by controlling the switching elements SW11 to SW14 of the bridge circuit 306 on the device 130 side thereof. Note that the total current I of the battery system 110 is a sum of currents to be assigned to the battery modules 111 when the battery modules 111 are connected in parallel with each other. When the battery modules 111 are connected in series, the total current I is the same on the device 130 side of the DC-DC converter 114, and is assumed to be divided among the battery modules 111 in a manner similar to the case of parallel connection. Thus, the relation of formula (26) is satisfied.

[Formula 26]

I=I_{1b}+I_{nb}(A) (26)

To reduce Joule heat, the output control unit 127 determines a current I_{1b} to be assigned to the battery module 111-1 as in formula (27), and determines a current I_{nb} to be assigned to the battery module 111-n as in formula (28).

$$[ Formula 27 ]$$

$${I}_{1 b} = \frac{{R}_{n}}{{R}_{1} + {R}_{n}} ⨯ I ( A ) \qquad ( 27 )$$

$$[ Formula 28 ]$$

$${I}_{nb} = \frac{{R}_{1}}{{R}_{1} + {R}_{n}} ⨯ I ( A ) \qquad ( 28 )$$

The output control unit 127 can calculate the output P₁ of the battery module 111-1 by obtaining a product of the voltage V_{1b} and the current I_{1b} of the battery module 111-1 as expressed by formula (29), and calculate the output Pₙ of the battery module 111-n by obtaining a product of the voltage V_{nb} and the current I_{nb} of the battery module 111-n as expressed by formula (30).

[Formula 29]

P₁=V_{1b}×I_{1b}(W) (29)

[Formula 30]

Pₙ=V_{nb}×I_{nb}(W) (30)

Next, methods of dividing output performed by the output control unit 127 of the charge and discharge control device 120 in the aforementioned eight patterns of comparison of parameters will be described. Note that, in the description below, the output control unit 127 of the charge and discharge control device 120 is assumed to divide a required output of 100 [W] among two battery modules 111.

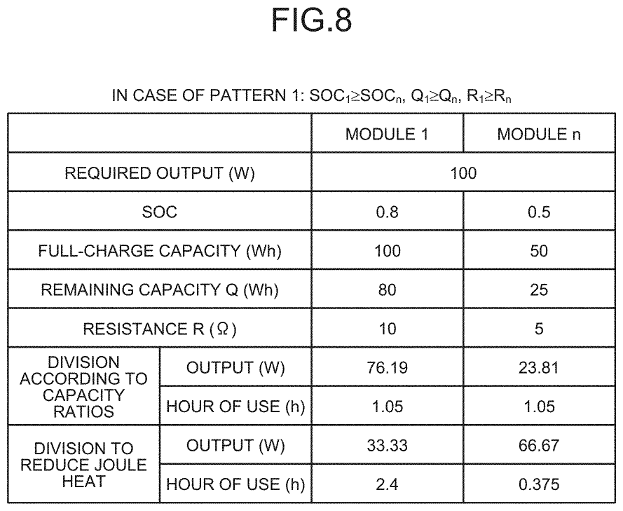

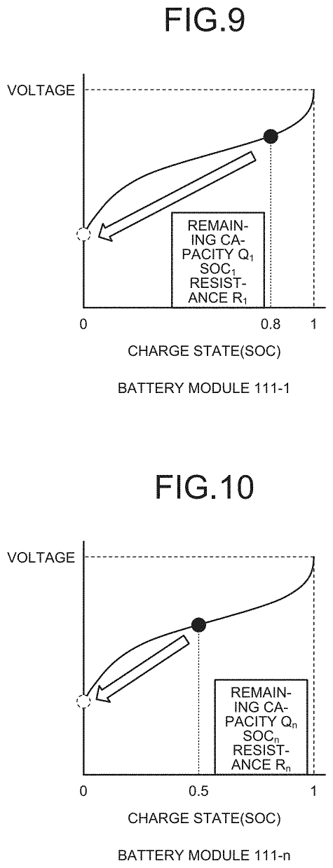

A case of pattern 1: SOC₁≥SOCₙ, Q₁≥Qₙ, and R₁≥Rₙ will be described. FIG. 8 is a table illustrating an example of division of output performed by the output control unit 127 of the charge and discharge control device 120 according to the embodiment in the case of pattern 1: SOC₁≥SOCₙ, Q₁≥Qₙ, and R₁≥Rₙ. FIG. 8 illustrates parameters when the charge state SOCₙ of the battery module 111-n is smaller than the charge state SCC₁ of the battery module 111-1, that is, SOC₁≥SOCₙ, and Q₁≥Qₙ and R₁≥Rₙ. Note that, in FIG. 8, for simplicity of description, the battery module 111-1 is described as module 1, and the battery module 111-n is described as module n. The same applies in the figure of each pattern mentioned below. In addition, FIG. 9 is a graph illustrating an example of a discharge curve of the battery module 111-1 when the output control unit 127 of the charge and discharge control device 120 according to the embodiment divides output in pattern 1. FIG. 10 is a graph illustrating an example of a discharge curve of the battery module 111-n when the output control unit 127 of the charge and discharge control device 120 according to the embodiment divides output in pattern 1.

When division in accordance with capacity ratios is performed in the condition of pattern 1, the output control unit 127 calculates the output P_{1q} of the battery module 111-1 as in formula (31), and calculates the output of the battery module 111-n as in formula (32).

$$[ Formula 31 ]$$

$${P}_{1 q} = \frac{{Q}_{1}}{{Q}_{1} + {Q}_{n}} P = \frac{80}{80 + 25} ⨯ 100 = 76.19 W \qquad ( 31 )$$

$$[ Formula 32 ]$$

$${P}_{nq} = \frac{{Q}_{n}}{{Q}_{1} + {Q}_{n}} P = \frac{25}{80 + 25} ⨯ 100 = 23.81 W \qquad ( 32 )$$

The hour of use of the battery module 111-1 when the output P_{1q} is as expressed by formula (31) is expressed by formula (33), and the hour of use of the battery module 111-n when the output P_{nq} is as expressed by formula (32) is expressed by formula (34).

$$[ Formula 33 ]$$

$$Hour of use of battery module 111 - 1 = \frac{80}{76.19} = 1.05 ( h ) \qquad ( 33 )$$

$$[ Formula 34 ]$$

$$Hour of use of battery module 111 - n = \frac{25}{23.81} = 1.05 ( h ) \qquad ( 34 )$$

In the case of performing division to reduce Joule heat in the condition of pattern 1, when the voltages of the battery modules 111-1 and 111-n are each assumed to be 20 V, the current flowing through the battery modules 111-1 and 111-n is 100 [W]÷20 [V]=5 [A]. Accordingly, the output control unit 127 calculates the current I_{1b} of the battery module 111-1 as in formula (35), and calculates the current I_{nb} of the battery module 111-n as in formula (36).

$$[ Formula 35 ]$$

$${I}_{1 b} = \frac{{R}_{n}}{{R}_{1} + {R}_{n}} ⨯ I = \frac{5}{10 + 5} ⨯ I = 1.67 ( A ) \qquad ( 35 )$$

$$[ Formula 36 ]$$

$${I}_{nb} = \frac{{R}_{1}}{{R}_{1} + {R}_{n}} ⨯ I = \frac{10}{10 + 5} ⨯ I = 3.33 ( A ) \qquad ( 36 )$$

The output control unit 127 calculates the output of the battery module 111-1 as in formula (37) using the current I_{1b} calculated according to formula (35), and calculates the output Pₙⱼ of the battery module 111-n as in formula (38) using the current I_{nb} calculated according to formula (36).

[Formula 37]

P₁ⱼ=V_{1b}×I_{1b}=20×1.67=33.33(W) (37)

[Formula 38]

PₙⱼV_{nb}×I_{nb}=20×3.33=66.67(W) (38)

The hour of use of the battery module 111-1 when the output P₁ⱼ is as expressed by formula (37) is expressed by formula (39), and the hour of use of the battery module 111-n when the output Pₙⱼ is as expressed by formula (38) is expressed by formula (40).

$$[ Formula 39 ]$$

$$Hour of use of battery module 111 - 1 = \frac{80}{33.33} = 2.4 ( h ) \qquad ( 39 )$$

$$[ Formula 40 ]$$

$$Hour of use of battery module 111 - n = \frac{25}{66.67} = 0.375 ( h ) \qquad ( 40 )$$

When the out control unit 127 has performed division of output by the method to reduce Joule heat, because the battery module 111-n ends operation, that is, is completely discharged in 0.375 h, Joule heat can be reduced but power remains in the battery module 111-1, and the efficiency of the battery system 110 is therefore lowered. Thus, when the comparison result corresponds to pattern 1, it is preferable that the output control unit 127 divide the required output in accordance with capacity ratios.

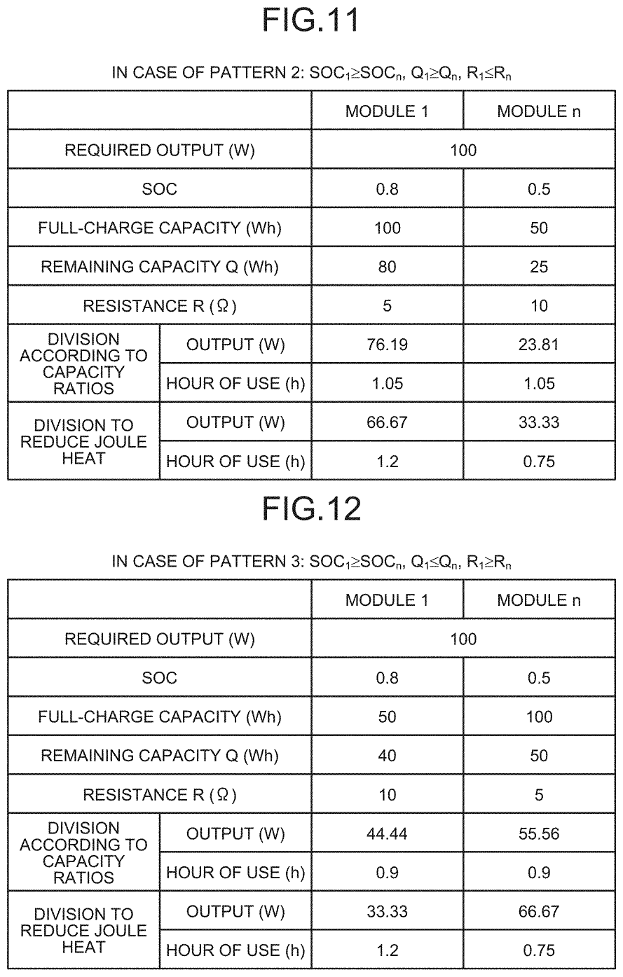

A case of pattern 2: SOC₁≥SOCₙ, Q₁≥Qₙ, and R₁≤Rₙ will be described. FIG. 11 is a table illustrating an example of division of output performed by the output control unit 127 of the charge and discharge control device 120 according to the embodiment an the case of pattern 2: SOC₁≥SOCₙ, Q₁≥Qₙ, and R₁≤Rₙ. FIG. 11 illustrates parameters in a case where the charge state SOCₙ of the battery module 111-n is smaller than the charge state SOC₁ of the battery module 111-1, that is, SOC₁≥SOCₙ, and Q₁≥Qₙ and R₁≤Rₙ. In pattern 2, the discharge curve of the battery module 111-1 is similar to that in FIG. 9, and the discharge curve of the battery module 111-n is similar to that in FIG. 10.

When division in accordance with capacity ratios is performed in the condition of pattern 2, the output control unit 127 calculates the output of 76.19 [W] and the hour of use of 1.05 [h] of the battery module 111-1 and calculates the output of 23.81 [W] and the hour of use of 1.05 [h] of the battery module 111-n according to calculation methods similar to those described above. In addition, when division to reduce Joule heat is performed in the condition of pattern 2, the output control unit 127 calculates the output of 66.67 [W] and the hour of use of 1.2 [h] of the battery module 111-1 and calculates the output of 33.33 [W] and the hour of use of 0.75 [h] of the battery module 111-n according to calculation methods similar to those described above. When the output control unit 127 performs division of output to reduce Joule heat, because the battery module 111-n ends operation, that is, is completely discharged first, power remains in the battery module 111-1, and the efficiency of the battery system 110 is therefore lowered. Thus, in the case where the comparison result corresponds to pattern 2, it is preferable that the output control unit 127 divide the required output in accordance with capacity ratios.

In the condition of R1≤Rn, however, the hour of use of the battery module 111-1 under division to reduce Joule heat may be longer than that of the battery module 111-n depending on the resistance ratio. For example, when the resistance R₁ of the battery module 111-1 is 2Ω and the resistance Rₙ of the battery module 111-n is 10Ω, the output and the hour of use of the battery module 111-1 are 83.33 [W] and 0.96 [h], respectively, and the output and the hour of use of the battery module 111-n are 16.67 [W] and 1.5 [h], respectively. In this case, when the battery system 110 is discharged at the outputs divided under control to reduce Joule heat by the output control unit 127, the battery module 111-1 is discharged faster, and the magnitude relation of the SOCs of the battery modules is reversed. Thus, the output control unit 127 may perform the division to reduce Joule heat until the magnitude relation of the SOCs is reversed, and switch the control after the relation of the SOCs is reversed. A method for switching the control will be described later.

A case of pattern 3: SOC₁≥SOCₙ, Q₁≤Qₙ, and R₁≥Rₙ will be described. FIG. 12 is a table illustrating an example of division of output performed by the output control unit 127 of the charge and discharge control device 120 according to the embodiment in the case of pattern 3: SOC₁≥SOCₙ, Q₁≤Qₙ, and R₁≥Rₙ. FIG. 12 illustrates parameters when the charge state SOCₙ of the battery module 111-n is smaller than the charge state SOC₁ of the battery module 111-1, that is, SOC₁≥SOCₙ, and Q₁≤Qₙ and R₁≥Rₙ. In pattern 3, the discharge curve of the battery module 111-1 is similar to that in FIG. 9, and the discharge curve of the battery module 111-n is similar to that in FIG. 10.

In the case of division in accordance with capacity ratios in the condition of pattern 3, the output control unit 127 calculates the output of 44.44 [W] and the hour of use of 0.9 [h] of the battery module 111-1 and calculates the output of 55.56 [W] and the hour of use of 0.9 [h] of the battery module 111-n according to calculation methods similar to those described above. In addition, when division to reduce Joule heat is performed in the condition of pattern 3, the output control unit 127 calculates the output of 33.33 [W] and the hour of use of 1.2 [h] of the battery module 111-1 and calculates the output of 66.67 [W] and the hour of use of 0.75 [h] of the battery module 111-n according to calculation methods similar to those described above. When the output control unit 127 performs division of output to reduce Joule heat, because the battery module 111-n ends operation, that is, is completely discharged first, power remains in the battery module 111-1, and the efficiency of the battery system 110 is therefore lowered. Thus, when the comparison result corresponds to pattern 3, it is preferable that the output control unit 127 divide the required output in accordance with capacity ratios.

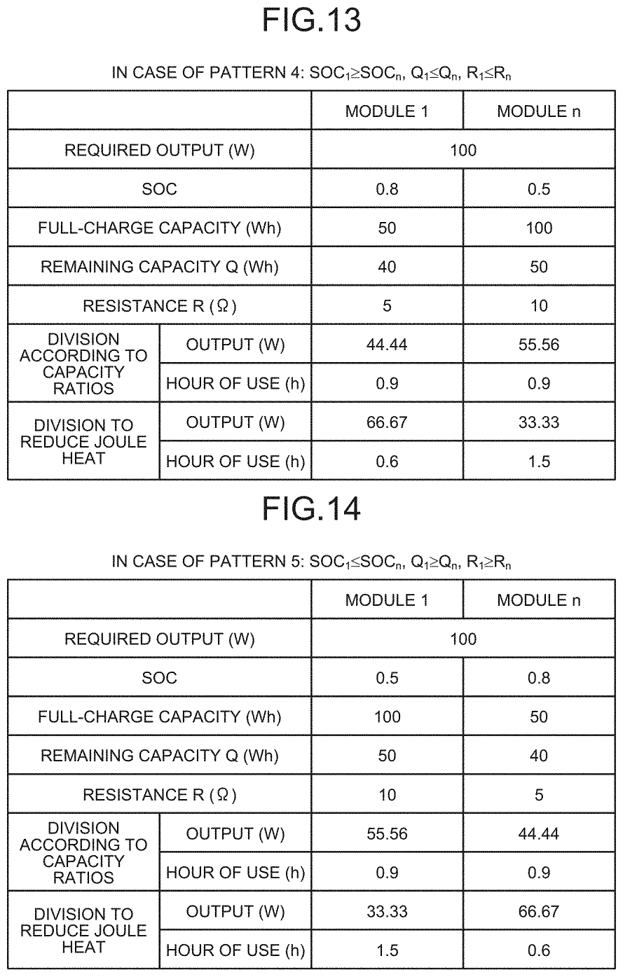

A case of pattern 4: SOC₁≥SOCₙ, Q₁≤Qₙ, and R₁≤Rₙ will be described. FIG. 13 is a table illustrating an example of division of output performed by the output control unit 127 of the charge and discharge control device 120 according to the embodiment in the case of pattern 4: SOC₁≥SOCₙ, Q₁≤Qₙ, and R₁≤Rₙ. FIG. 13 illustrates parameters when the charge state SOCₙ of the battery module 111-n is smaller than the charge state SOC₁ of the battery module 111-1, that is, SOC₁≥SOCₙ, and Q₁≤Qₙ and R₁≤Rₙ. In pattern 4, the discharge curve of the battery module 111-1 similar to that in FIG. 9, and the discharge curve of the battery module 111-n is similar to that in FIG. 10.

When division in accordance with capacity ratios is performed in the condition of pattern 4, the output control unit 127 calculates the output of 44.44 [W] and the hour of use of 0.9 [h] of the battery module 111-1 and calculates the output of 55.56 [W] and the hour of use of 0.9 [h] of the battery module 111-n according to calculation methods similar to those described above. In addition, in the case of division to reduce Joule heat in the condition of pattern 4, the output control unit 127 calculates the output of 66.67 [W] and the hour of use of 0.6 [h] of the battery module 111-1 and calculates the output of 33.33 [W] and the hour of use of 1.5 [h] of the battery module 111-n according to calculation methods similar to those described above. When the comparison result corresponds to pattern 4, because the hour of use of the battery module 111-1 becomes shorter and the difference of the battery module 111-1 in the SOC from the battery module 111-n can be made smaller, the output control unit 127 performs division of output to reduce Joule heat. Note that the magnitude relation of the SOCs of the battery modules changes through use. A method of control when the magnitude relation of the SOCs changes will be described later.

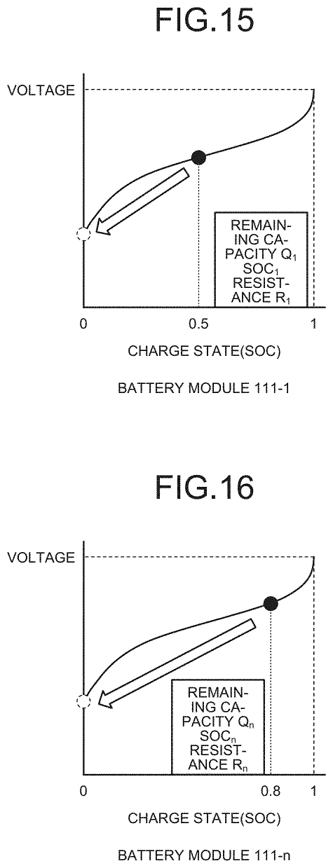

A case of pattern 5: SOC₁≤SOCₙ, Q₁≥Qₙ, and R₁≥Rₙ will be described. FIG. 14 is a table illustrating an example of division of output performed by the output control unit 127 of the charge and discharge control device 120 according to the embodiment in the case of pattern 5: SOC₁≤SOCₙ, Q₁≥Qₙ, and R₁≥Rₙ. FIG. 14 illustrates parameters in a case where the charge state SOCₙ of the battery module 111-n is larger than the charge state SOC₁ of the battery module 111-1, that is, SOC₁≤SOCₙ, and Q₁≥Qₙ and R₁≥Rₙ. FIG. 15 is a graph illustrating an example of a discharge curve of the battery module 111-1 when the output control unit 127 of the charge and discharge control device 120 according to the embodiment divides output in pattern 5. FIG. 16 is a graph illustrating an example of a discharge curve of the battery module 111-n when the output control unit 127 of the charge and discharge control device 120 according to the embodiment divides output in pattern 5.

Because the output of the battery module 111-n having the higher SOC becomes larger and the hour of use of the battery module 111-n becomes shorter in the division of output to reduce Joule heat than that in the division in accordance with capacity ratios, the output control unit 127 performs the division of output to reduce Joule heat. Note that the magnitude relation of the SOCs of the battery modules changes as a result of use. A method of control when the magnitude relation of the SOCs changes will be described later.

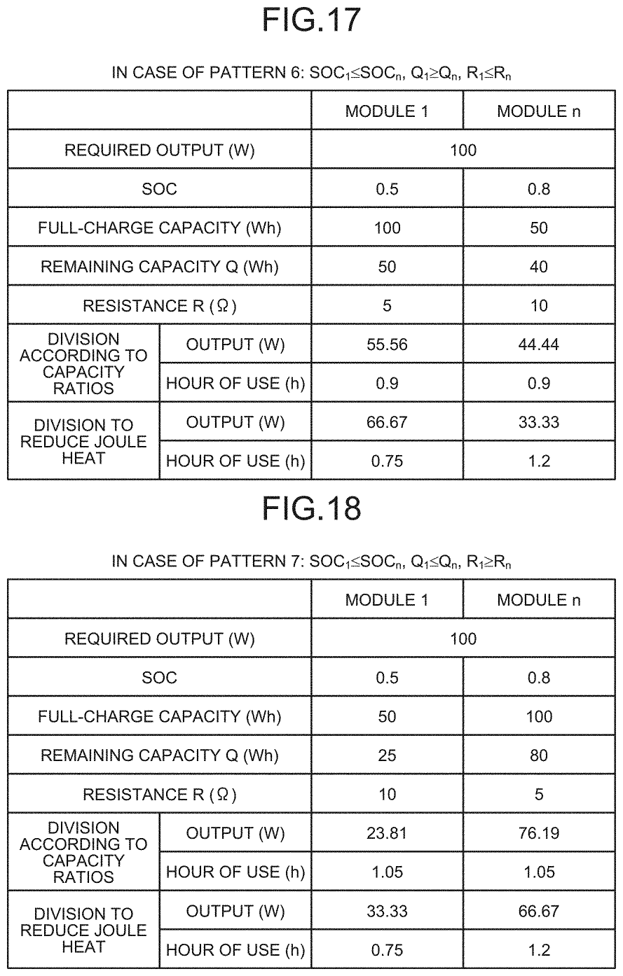

A case of pattern 6: SOC₁≤SOCₙ, Q₁≥Qₙ, and R₁≤Rₙ will be described. FIG. 17 is a table illustrating an example of division of output performed by the output control unit 127 of the charge and discharge control device 120 according to the embodiment in the case of pattern 6: SOC₁≤SOCₙ, Q₁≥Qₙ, and R₁≤Rₙ. FIG. 17 illustrates parameters when the charge state SOCₙ of the battery module 111-n is larger than the charge state SOC₁ of the battery module 111-1, that is, SOC₁≤SOCₙ, and Q₁≥Qₙ and R₁≤Rₙ. In pattern 6, the discharge curve of the battery module 111-1 is similar to that in FIG. 15, and the discharge curve of the battery module 111-n is similar to that in FIG. 16.

Because the output of the battery module 111-n having the higher SOC becomes smaller and the hour of use of the battery module 111-n becomes longer in the division of output to reduce Joule heat, the difference between the SOCs will not decrease. Thus, the output control unit 127 performs the division of output in accordance with capacity ratios.

A case of pattern 7: SOC₁≤SOCₙ, Q₁≤Qₙ, and R₁≥Rₙ will be described. FIG. 18 is a table illustrating an example of division of output performed by the output control unit 127 of the charge and discharge control device 120 according to the embodiment in the case of pattern 7: SOC₁≤SOCₙ, Q₁≤Qₙ, and R₁≥Rₙ. FIG. 18 illustrates parameters when the charge state SOCₙ of the battery module 111-n is larger than the charge state SOC₁ of the battery module 111-1, that is, SOC₁≤SOCₙ, and Q₁≤Qₙ and R₁≥Rₙ. In pattern 7, the discharge curve of the battery module 111-1 is similar to that in FIG. 15, and the discharge curve of the battery module 111-n is similar to that in FIG. 16.

In a manner similar to the case of pattern 6, because the output of the battery module 111-n having the higher SOC becomes smaller and the hour of use of the battery module 111-n becomes longer in the division of output to reduce Joule heat, the difference between the SOCs will not decrease. Thus, the output control unit 127 performs the division of output in accordance with capacity ratios.

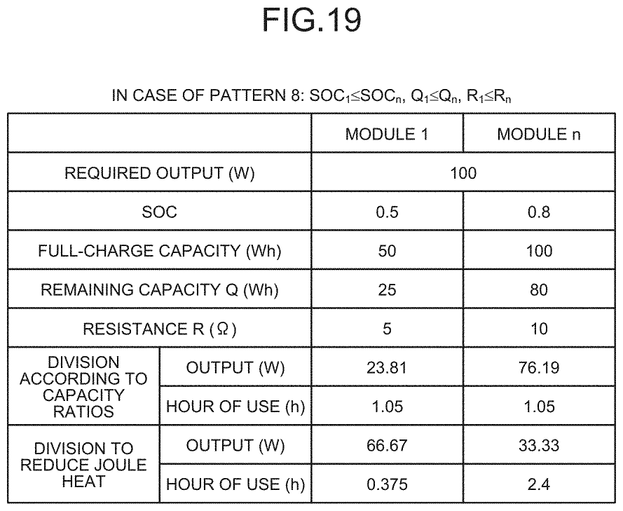

A case of pattern 8: SOC₁≤SOCₙ, Q₁≤Qₙ, and R₁≤Rₙ will be described. FIG. 19 is a table illustrating an example of division of output performed by the output control unit 127 of the charge and discharge control device 120 according to the embodiment in the case of pattern 8: SOC₁≤SOCₙ, Q₁≤Qₙ, and R₁≤Rₙ. FIG. 19 illustrates parameters when the charge state SOCₙ of the battery module 111-n is larger than the charge state SOC₁ of the battery module 111-1, that is, SOC₁≤SOCₙ, and Q₁≤Qₙ and R₁≤Rₙ. In pattern 8, the discharge curve of the battery module 111-1 is similar to that in FIG. 15, and the discharge curve of the battery module 111-n is similar to that in FIG. 16.

In a manner similar to the cases of pattern 6 and pattern 7, because the output of the battery module 111-n having the higher SOC becomes smaller and the hour of use of the battery module 111-n becomes longer in the division of output to reduce Joule heat, the difference between the SOCs will not decrease. Thus, the output control unit 127 performs the division of output in accordance with capacity ratios.

In the examples of pattern 1 to pattern 8 described above, the parameters are determined in any way and the output control unit 127 performs division of output. However, the control method varies depending on the ratios of the resistances R. Thus, the output control unit 127 is preferably used for division in accordance with capacity ratios when the discharge time of a battery module 111 having a high SOC is long, and is preferably used for division to reduce Joule heat when the discharge time of a battery module 111 having a high SOC is short.

In addition, although comparison of the parameters is performed at the start of control in the examples of pattern 1 to pattern 8 described above, the output control unit 127 need not keep the same method of division of output until the end of operation on the basis of the comparison result at the start of control because SOCs, remaining capacities Q, resistances R, and the like change with time. In other words, the output control unit 127 may switch the method of division of output at timing of SOC₁=SOCₙ, Q₁=Qₙ, or R₁=Rₙ as charging or discharging progresses.

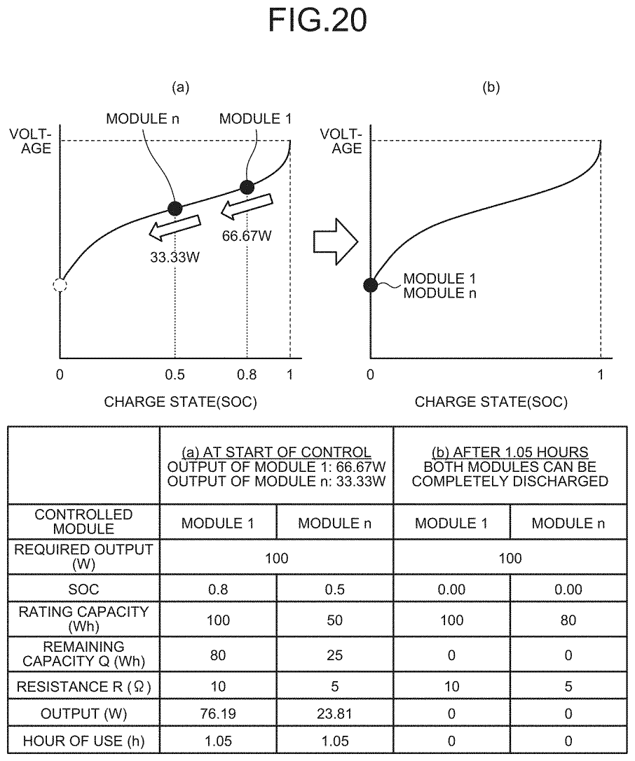

FIG. 20 is a diagram illustrating an example of discharge curves of the individual battery module 111-1 and 111-n when the output control unit 127 of the charge and discharge control device 120 according to the embodiment performs division of output in pattern 1. In FIG. 20, similarly to FIG. 8 and the like, the battery module 111-1 is described as “module 1”, and the battery module 111-n is described as “module n” for simple description. The same applies to the figure of each pattern mentioned below. When the comparison result of parameters corresponds to the condition of pattern 1, the output control unit 127 can use both of the battery modules 111-1 and 111-n completely to the SOC of 0% at the end of operation with outputs obtained by division in accordance with capacity ratios determined at the start of control as illustrated in FIG. 20. Thus, when the comparison result of the parameters corresponds to the condition in pattern 1, the output control unit 127 need not change the method for dividing output from the start of the control until the end of operation.

Next, in the method of dividing output to reduce Joule heat when the comparison result of the parameters corresponds to the condition in pattern 4, assume a case where the output control unit 127 uses the battery module 111-1 with an output of 66.67 W for an hour of use of 0.6 h and the battery module 111-n with an output of 33.33 W for an hour of use of 1.5 h. In this case, because the battery system 110 detects end of discharge at the hour of use of 0.6 h of the battery module 111-1, the discharge ends before the battery module 111-n is completely discharged. Note that, in the case of pattern 4, while the SOC₁ of the battery module 111-1 is higher than the SOCₙ of the battery module 111-n at the start of control, the SOCₙ of the battery module 1111-n becomes higher than the SOC₁ of the battery module 111-1 through use because the decreasing speed of the SOC₁ of the battery module 111-1 is higher. Thus, it is expected that the comparison result of the parameters at the start of control changes to the comparison result in pattern 8. In this case, the output control unit 127 switches the method for division of output from the method of dividing output to reduce Joule heat to the division in accordance with capacity ratios. As described above, because SOCs, remaining capacities Q, and resistances R change with time, the output control unit 127 controls charging and discharging by switching the control on division of output, that is, the method of division of output when the parameter comparison result changes.

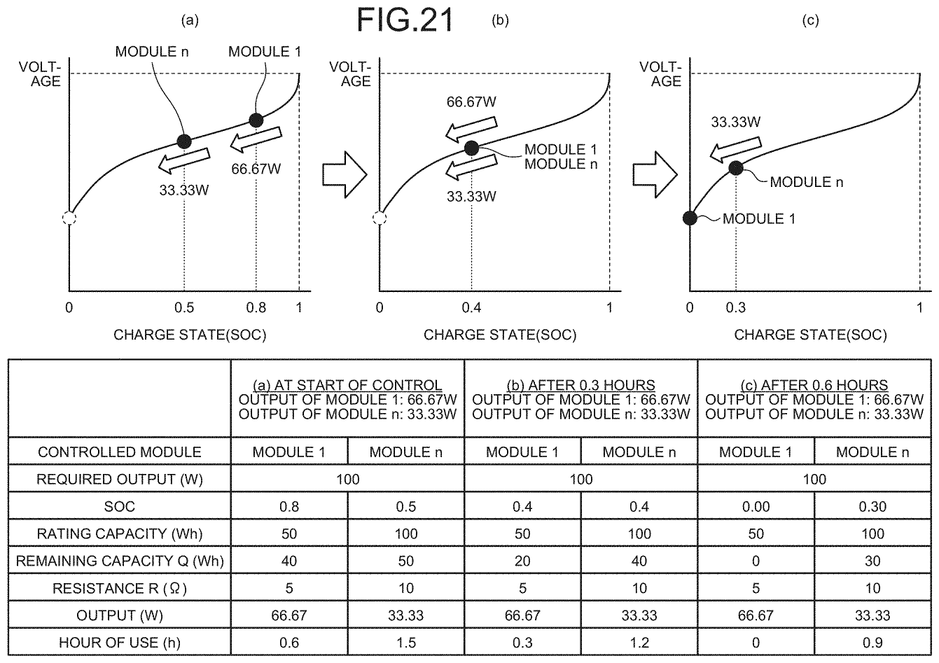

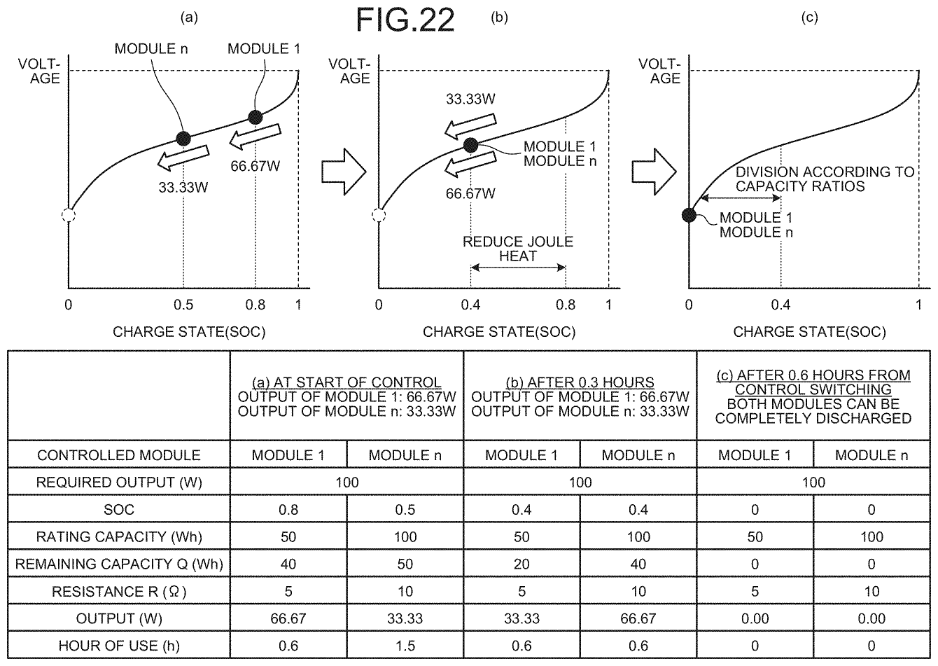

Discharge curves of the battery modules 111-1 and 111-n when the output control unit 127 does not switch the method of dividing output and when the output control unit 127 switches the method of dividing output will be explained. FIG. 21 is a diagram illustrating an example of discharge curves when the output control unit 127 of the charge and discharge control device 120 according to the embodiment does not switch the method of dividing output. FIG. 22 is a diagram illustrating an example of discharge curves when the output control unit 127 of the charge and discharge control device 120 according to the embodiment switches the method of dividing output.

FIG. 21 illustrates a case where the output control unit 127 does not switched the method of dividing output from the start of control when the comparison result corresponds to pattern 4. In this case, as described above, because the battery system 110 detects end of discharge at the hour of use of 0.6 h of the battery module 111-1, the discharge ends before the battery module 111-n is completely discharged.

FIG. 22 illustrates a case where the output control unit 127 has switched the method of dividing output 0.3 hours after the start of control when the comparison result corresponds to pattern 4. The SOC₁ of the battery module 111-1 and the SOCₙ of the battery module 111-n become an equal value of 0.4 at 0.3 hours after the start of control. The output control unit 127 switches the method for dividing output to the division in accordance with capacity ratios so that the output of the battery module 111-n with a larger remaining capacity Q increases. As a result, the battery system 110 can completely discharge the battery module 111-n.

As described above, the output control unit 127 compares the charge state of the battery module 111-n, which is the reference, with the charge state of the other battery module 111, and selects whether to divide output in accordance with capacity ratios or to divide output to reduce Joule heat.

When the charge state of the battery module 111-n, which is the reference, is lower than the charge state of the other battery module 111, and an output of the other battery module 111 obtained by the division to reduce Joule heat is larger than an output of the other battery module 111 determined by the division in accordance with capacity ratios, the output control unit 127 divides output to reduce Joule heat and performs control to reduce the Joule heat. When the charge states of the battery modules 111 have changed and the charge state of the battery module 111-n, which is the reference, has become equal to the charge state of the other battery module 111, the output control unit 127 switches to control of dividing output in accordance with capacity ratios. When the charge state of the battery module 111-n, which is the reference, is lower than the charge state of the other battery module 111, and an output of the other battery module 111 obtained by the division to reduce Joule heat is smaller than an output of the other battery module 111 determined by the division in accordance with capacity ratios, the output control unit 127 divides output in accordance with capacity ratios.

Furthermore, when the charge state of the battery module 111-n, which is the reference, is higher than the charge state of the other battery module 111, and an output of the battery module 111-n, which is the reference, obtained by the division to reduce Joule heat is larger than an output of the battery module 111-n determined by the division in accordance with capacity ratios, the output control unit 127 divides output to reduce Joule heat and performs control to reduce the Joule heat. When the charge states of the battery modules 111 have changed and the charge state of the battery module 111-n, which is the reference, has become equal to the charge state of the other battery module 111, the output control unit 127 switches to control of dividing output in accordance with capacity ratios. When the charge state of the battery module 111-n, which is the reference, is higher than the charge state of the other battery module 111, and when an output of the battery module 111-n, which is the reference, obtained by the division to reduce Joule heat is smaller than an output of the battery module 111-n determined by the division in accordance with capacity ratios, the output control unit 127 divides output in accordance with capacity ratios.

While the cases where the charge and discharge control device 120 performs discharge has been specifically described in the embodiment, the charge and discharge control device 120 is not limited thereto. The charge and discharge control device 120 can control division among the battery modules 111 during charging by similar control. During charging, the difference between a full-charge capacity and a remaining capacity is a chargeable capacity, and the charge and discharge control device 120 performs comparison by using the relation of the chargeable capacities instead of the remaining capacities. The output control unit 127 of the charge and discharge control device 120 compares the parameters of the battery module 111-n, which is the reference, and switches between the division of output in accordance with capacity ratios and the division of output to reduce Joule heat as charging or discharging progresses.

In addition, while a case where the charge and discharge control device 120 controls the method of dividing output of the battery system 110 including two battery modules 111 has been described, the method of dividing output of a battery system 110 including three or more battery modules 111 can also be controlled by similar control. In addition, while the methods of dividing output during discharging performed by charge and discharge control device 120 are described in the present embodiment, a discharge control device that only performs control of discharge of the battery system 110, may perform control by similar methods of dividing output during discharging.

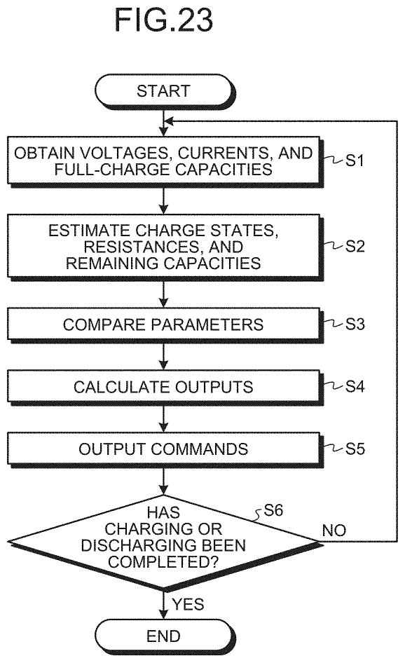

The operation of the charge and discharge control device 120 will be described with reference to a flowchart, FIG. 23 is a flowchart illustrating the operation of charge and discharge control performed by the charge and discharge control device 120 according to the embodiment. Upon starting charge and discharge control, the charge and discharge control device 120 obtains information on voltage, current, and capacity of each of the battery modules 111 from the DC-DC converters 114 (step S1). Specifically, as described above, the current obtaining unit 121 obtains information on current, the voltage obtaining unit 123 obtains information on voltage, and the capacity obtaining unit 122 estimates full-charge capacity. The charge and discharge control device 120 estimates the SOC, which is a charge state, the resistance R, and the remaining capacity Q of each of the battery modules 111 by using the information on the voltage, current, and capacity (step S2). Specifically, as described above, the SOC estimating unit 124 estimates the SOC that is a charge state, the resistance estimating unit 125 estimates the resistance R, and the remaining capacity estimating unit 126 estimates the remaining capacity Q.

In the charge and discharge control device 120, the output control unit 127 compares the respective parameters of the individual battery modules 111 estimated in step S2, that is specifically, the SOCs that are charge states, the remaining capacities Q, and the resistances R of the battery modules 111 (step S3). The output control unit 127 calculates outputs assigned to the individual battery modules 111 on the basis of the comparison result in step S3 (step S4), generates output commands and transmits the output commands to the battery modules 111 (step S5). If charging or discharging of the battery system 110 has not been completed (step S6: NO), the charge and discharge control device 120 returns the process to step S1 and repeats the operation described above. If charging or discharging of the battery system 110 has been completed (step S6: Yes), the charge and discharge control device 120 terminates the charge and discharge control.

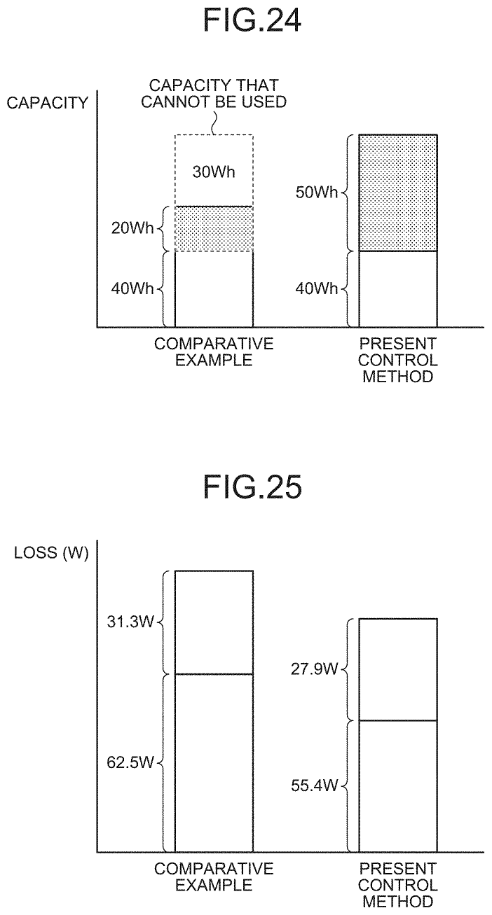

Effects produced by the control of division of output in the embodiment will be explained. FIG. 24 is a first graph illustrating an effect produced by the charge and discharge control device 120 according to the embodiment. Here, assume a case where a first battery module has a remaining capacity Q of 50 Wh and a resistance R of 5Ω, and a second battery module has a remaining capacity Q of 40 Wh and a resistance R of 10Ω. In a comparative example in which a required output is divided into equal powers among the battery modules 111, a capacity of 30 Wh of the first battery module cannot be used, and the performance of the battery system 110 is limited to that of a battery module 111 with a low SOC, thereby lowering the efficiency. In contrast, in the present control method, entire power of the battery modules 111 can be used, which can improve the efficiency of the battery system 110. In addition, while an example of battery modules 111 having different characteristics have been described in the embodiment, degraded batteries of the same type can be used, which is expected to lower the cost of the battery system 110.

FIG. 25 is a second graph illustrating an effect produced by the charge and discharge control device 120 according to the embodiment. Here, assume a case where a current of 5 A in total is divided among the first and second battery modules in the condition similar to that in FIG. 24. In a comparative example in which a required output is divided into equal powers among the battery modules 111, a loss of 2.5²×10=62.5 W occurs in the second battery module, and a loss of 2.5²×5=31.3 W occurs in the first battery module. In contrast, in the present control method, because a current of 5 A is divided in accordance with resistance ratios, a loss of 3.33²×5=55.4 W occurs in the first battery modules, and a loss of 1.67²×10=27.9 W occurs in the second battery module. In this manner, the losses of the battery system 110 can be reduced in the present control method as compared with the comparative example.

Next, a hardware configuration of the charge and discharge control device 120 will be described. In the charge and discharge control device 120, all the components from the current obtaining unit 121 to the output control unit 127 are implemented by processing circuitry. The processing circuitry may be constituted by a processor that executes programs stored in a memory and the memory, or may be dedicated hardware.

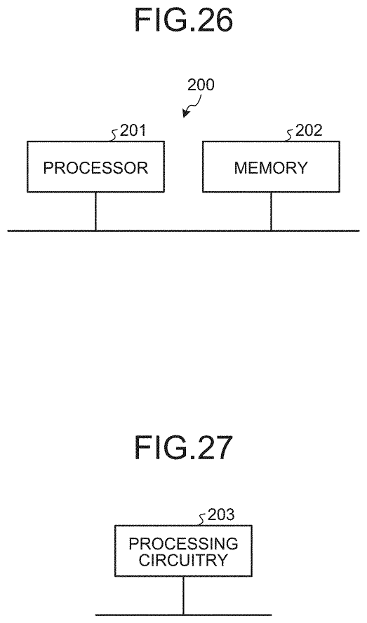

FIG. 26 is a diagram illustrating an example of a case where processing circuitry 200 included in the charge and discharge control device 120 according to the embodiment is constituted by a processor 201 and a memory 202. When the processing circuitry 200 is constituted by the processor 201 and the memory 202, the functions of the processing circuitry 200 of the charge and discharge control device 120 are implemented by software, firmware, or a combination of software and firmware. The software or firmware is described in the form of programs and stored in the memory 202. The processing circuitry 200 implements the functions by reading and executing the programs stored in the memory 202 by the processor 201. Specifically, the processing circuitry 200 includes the memory 202 for storing programs that results in execution of processes of the charge and discharge control device 120. In other words, the programs cause a computer to execute the procedures and the methods of the charge and discharge control device 120.

Note that the processor 201 may be a central processing unit (CPU), a processing device, a computing device, a microprocessor, a microcomputer, a digital signal processor (DSP), or the like. In addition, the memory 202 is a nonvolatile or volatile semiconductor memory such as a random access memory (RAM), a read only memory (ROM), a flash memory, an erasable programmable ROM (EPROM), or an electrically EPROM (EEPROM: registered trademark), a magnetic disk, a flexible disk, an optical disk, a compact disc, a mini disc, a digital versatile disc (DVD) or the like, for example.

FIG. 27 is a diagram illustrating an example of a case where the processing circuitry 203 included in the charge and discharge control device 120 according to the embodiment is constituted by dedicated hardware. When the processing circuitry 203 is constituted by dedicated hardware, the processing circuitry 203 illustrated in FIG. 27 is a single circuit, a composite circuit, a programmed processor, a parallel-programmed processor, an application specific integrated circuit (ASIC), a field programmable gate array (FPGA), or a combination thereof, for example. The functions of the charge and discharge control device 120 may be implemented separately by the processing circuitry 203 function by function, or may be implemented collectively by the processing circuitry 203.

Note that some of the functions of the charge and discharge control device 120 may be implemented by dedicated hardware, and others may be implemented by software or firmware. As described above, the processing circuitry is capable of implementing the above-described functions by dedicated hardware, software, firmware, or a combination thereof.

As described above, according to the embodiment, the charge and discharge control device 1120 obtains information on the states of the battery modules 111-1 to 111-m of the battery system 110 from the battery modules 111-1 to 111-m, estimates parameters indicating the states of the battery modules 111-1 to 111-m, and controls division of output among the battery modules 111-1 to 111-m so that the differences between the charge states of the battery modules 111-1 to 111-m become smaller on the basis of the comparison result of comparing the parameters. As a result, the charge and discharge control device 120 can reduce or prevent decrease in the efficiency of the battery system 110 including the battery modules 111-1 to 111-m having different characteristics from each other. The charge and discharge control device 120 assigns a high output to a battery module 111 having a low resistance R, and can thus charge and discharge the battery system 110 constituted by the battery modules 111 having different characteristics from each other without lowering the efficiency of the battery system 110.

In addition, under the control performed by the charge and discharge control device 120, the charge and discharge control system 100 can have a configuration in which the battery system 110 includes battery modules 111 with low costs, and a lower cost of the battery system 110 is therefore expected. Furthermore, even when a failure or the like occurs, it is not necessary to replace the entire battery system 110 and it is sufficient that only a battery module 111 is replaced, which can improve the maintenance efficiency of the charge and discharge control system 100.

The configurations presented in the embodiment above are examples, and can be combined with other known technologies or with each other, or can be partly omitted or modified without departing from the gist.

### REFERENCE SIGNS LIST

100 charge and discharge control system; 110 battery system; 111-1 to 111-m battery module; 112 cell; 113 BMU; 114 DC-DC converter; 115 unit; 120 charge and discharge control device; 121 current obtaining unit; 122 capacity obtaining unit; 123 voltage obtaining unit; 124 SOC estimating unit; 125 resistance estimating unit; 126 remaining capacity estimating unit; 127 output control unit; 128 obtainment unit; 129 estimation unit; 130 device; 301, 309 voltmeter; 302, 308 ammeter; 303, 307 capacitor; 304, 306 bridge circuit; 305 transformer; 310 controller; SW1 to SW4, SW11 to SW14 switching element.

1. A charge and discharge control device to be connected to a battery system including a plurality of battery modules, the charge and discharge control device comprising:
processing circuitry
to obtain information on states of the battery modules;
to estimate a parameter indicating each of the states of the battery modules by using the information on the states of the battery modules obtained; and
to compare the parameters of the battery modules estimated, and control division of output among the battery modules so as to reduce difference between charge states of the battery modules on the basis of a result of comparison.

2. The charge and discharge control device according to claim 1, wherein
the battery system is constituted by the battery modules being replaceable and having different characteristics from each other.

3. The charge and discharge control device according to claim 1, wherein
the processing circuitry estimates charge states, capacity values, and resistances of the battery modules as the parameters indicating the states of the battery modules.

4. The charge and discharge control device according to claim 1, wherein
the processing circuitry compares the charge state of one of the battery modules being a reference with the charge state of another one of the battery modules, and selects whether to divide output in accordance with capacity ratios or to divide output so as to reduce Joule heat.

5. The charge and discharge control device according to claim 1, wherein
in a case where the charge state of one of the battery modules being a reference is lower than the charge state of another one of the battery modules, when an output of the another battery module obtained by division to reduce Joule heat is larger than an output of the another battery module determined by division in accordance with capacity ratios, the processing circuitry divides output to reduce Joule heat and performs control to reduce the Joule heat.

6. The charge and discharge control device according to claim 1, wherein
in a case where the charge state of one of the battery modules being a reference is lower than the charge state of another one of the battery modules, when an output of the another battery module obtained by division to reduce Joule heat is smaller than an output of the another battery module determined by division in accordance with capacity ratios, the processing circuitry divides output in accordance with capacity ratios.

7. The charge and discharge control device according to claim 1, wherein
in a case where the charge state of one of the battery modules being a reference is higher than the charge state of another one of the battery modules, when an output of the battery module being the reference obtained by division to reduce Joule heat is larger than an output of the battery module being the reference determined by division in accordance with capacity ratios, the processing circuitry divides output to reduce Joule heat and performs control to reduce the Joule heat.

8. The charge and discharge control device according to claim 1, wherein
in a case where the charge state of one of the battery modules being a reference is higher than the charge state of another one of the battery modules, when an output of the battery module being the reference obtained by division to reduce Joule heat is smaller than an output of the battery module being the reference determined by division in accordance with capacity ratios, the processing circuitry divides output in accordance with capacity ratios.

9. The charge and discharge control device according to claim 1, wherein
the processing circuitry uses the parameter of one of the battery modules being a reference for comparison and switches between division of output in accordance with capacity ratios and division of output to reduce Joule heat as charging or discharging progresses.

10. A charge and discharge control method for a charge and discharge control device to be connected with a battery system including a plurality of battery modules, the charge and discharge control method comprising:
obtaining information on states of the battery modules;
estimating a parameter indicating each of the states of the battery modules by using the information on the states of the battery modules obtained; and
comparing the parameters of the battery modules estimated, and controlling division of output among the battery modules so as to reduce difference between charge states of the battery modules on the basis of a result of comparison.
